(19) United States
(12) Patent Application Publication
(10) Pub. No.: US 2026/0142060 A1
(43) Pub. Date: May 21, 2026

(54) BUSHING CONNECTOR COVER FOR HIGH VOLTAGE EQUIPMENT COVERING CLAMP HANDWHEEL

(71) Applicant: ECO ELECTRICAL SYSTEMS, INC, Reno, NV (US)

(72) Inventor: Michael Lynch, Reno, NV (US)

(73) Assignee: ECO ELECTRICAL SYSTEMS, INC, Reno, NV (US)

(21) Appl. No.: 19/452,075

(22) Filed: Jan. 16, 2026

Related U.S. Application Data
(63) Continuation-in-part of application No. 18/945,337, filed on Nov. 12, 2024.

(51) Int. Cl. H01B 17/58

(52) U.S. Cl. CPC H01B 17/583

(57) ABSTRACT

A dielectric bushing cover, for use with high voltage components, securely connects to the bushing and includes an expanded portion for surrounding a grippable handwheel that is used for clamping a wire to the metal connector of the bushing. In this way, the energized handwheel is not exposed to the elements to prevent flashover between the handwheel and the cover.

### CROSS-REFERENCE TO RELATED APPLICATIONS

This application is a continuation-in-part of US application serial number 18/945,337, filed November 12, 2024, by Michael Lynch, incorporated herein by reference.

### FIELD OF THE INVENTION

The invention relates to a dielectric bushing cover for high voltage components, such as transformers.

### BACKGROUND

In the field of high voltage equipment, such as for use with 12KV or more, it is sometimes important that energized metal parts be protected by a dielectric cover to prevent animals, such as birds and squirrels, from creating a short between the energized metal and a grounded structure or a short between two phases. The cover may also prevent flashovers when water, made conductive with the addition of contaminants, comes in contact with the energized parts.

FIG. 1 illustrates a top portion of a conventional ceramic bushing 10 that has a hole extending through its length. The bushing’s skirts 11 prevent water from forming a continuous path between the top and bottom of the bushing 10. The top end of the bushing 10 has a metal connector 12 (e.g., a clamp) that receives a high voltage conductor 13 (a wire), where a nut 14 is tightened to clamp the connector 12 onto the conductor 13. Another conductor extends from the connector 12, through the center axis of the bushing 10, and to another electrical connector at the bottom of the bushing 10 for connection to, for example, a transformer.

The bottom portion 15 of the metal connector 12 is circular. The bushing 10 usually has a metal support structure near its bottom end that is bolted to a transformer’s grounded housing for supporting the bushing 10. Such bushings 10 may be used with any high voltage equipment, such as reclosers, capacitors, regulators, etc.

In the examples given below, it is assumed that the bushing 10 extends from a grounded transformer housing, where a bird may build a nest on the top of the transformer housing. The nest’s twigs may contact the bushing.

FIG. 2 illustrates a transformer 16, having a grounded housing 18 containing a transformer, such as for converting 12KV to a household voltage. Two bushings 10 are shown attached to the top of the transformer 16.

FIG. 3 illustrates the structure of FIG. 1 where a grippable plastic handwheel 20 has the nut 14 (FIG. 1) fixed within its end to allow the lines-person to manually tighten the nut 14 without tools. The handwheel 20 remains on the bushing 10.

FIG. 4 illustrates a prior art plastic bushing cover 22 having a slotted opening 24 or hole for the handwheel 20 so the handwheel 20 can be accessed by the lines-person without removing the cover. The slot or hole goes over the narrow portion of the handwheel 20, and the handwheel 20 extends out from the cover. The handwheel 20 does not directly touch the cover. In such a structure, the plastic handwheel 20 is directly connected to the energized metal of the connector 12. The grounded transformer housing 26 is connected to a grounded utility pole 28.

The Applicant was informed of a problem with a high voltage transformer bushing cover used in the field, similar to the cover 22 in FIG. 4. The bushing cover had a handwheel 20 extending from it, and the cover surface near the handwheel 20 was blackened by a flashover and partially melted. The handwheel 20 was also burnt. The Applicant came to the nonobvious conclusion that slightly-conductive moisture collecting on the cover and exposed handwheel initiated a conductive bridge between the grounded cover and the energized plastic handwheel 20. This caused a voltage arc (flashover) or a low, prolonged leakage (shorting) current to be conducted between the bushing’s metal connector, the neck of the handwheel 20, and the cover 22.

What is needed is an improvement to the prior art plastic bushing cover that will prevent the cover from being burned and melted due to a conductive moisture bridge between the exposed handwheel 20 and the cover.

### SUMMARY

A dielectric (e.g., polymer) bushing cover, for use with high voltage components, is described that covers the metal connector for a conductor (a wire) and also completely covers a plastic handwheel that is used to turn a nut that clamps the connector to the conductor. The handwheel directly contacts the energized metal connector and nut.

The cover is formed of two sections connected by a hinge portion. The two sections are positioned around the metal connector and handwheel, and the two sections are resiliently snapped together to secure the cover to the bushing. There is an air gap between the cover and the handwheel and between any other energized part. The bottom of the cover frictionally secures around the top of the bushing to prevent slippage of the cover.

The same cover may be used with metal connectors that do not use a handwheel, or with connectors using short or long handwheel necks.

Accordingly, no moisture contacts the handwheel and no conductive bird’s nest can create a conductive bridge between the handwheel and a grounded structure, such as the cover.

Other embodiments are envisioned.

### BRIEF DESCRIPTION OF THE DRAWINGS

FIG. 1 illustrates a conventional bushing, showing a top metal connector for securing an energized wire.

FIG. 2 illustrates a conventional transformer having two bushings extending from the top of the grounded metal housing of the transformer. The transformer receives a high voltage input and outputs a household voltage.

FIG. 3 illustrates the bushing of FIG. 1 with a plastic handwheel over the nut that is used to clamp the wire to the metal connector.

FIG. 4 illustrates a prior art plastic bushing cover having an opening for the handwheel so the handwheel can be accessed by the lines-person without removing the cover.

FIG. 5 is a side-transparent view of a cover, in accordance with one embodiment of the invention, where the cover surrounds the handwheel used for clamping the wire to the metal connector.

FIG. 6 is a front transparent view of the cover showing a snap-connector, that secures the two halves of the cover together, and a hinge portion of the cover. FIG. 6 also shows an inner molded bottom section of the cover that securely fits over the top skirt of the bushing insulator to prevent slippage.

FIG. 7 is a top-down transparent view of the cover showing the snap-connector and the hinge and also showing molded tabs internal to the cover that securely fit under and over the top skirt of the ceramic bushing for securing the cover in place.

FIG. 8 is similar to FIG. 5 but the handwheel has a shorter neck.

FIG. 9 shows the same cover over a bushing that does not use a handwheel.

FIG. 10 shows the inner portion of the cover when open.

FIG. 11 shows the outside of the cover when open.

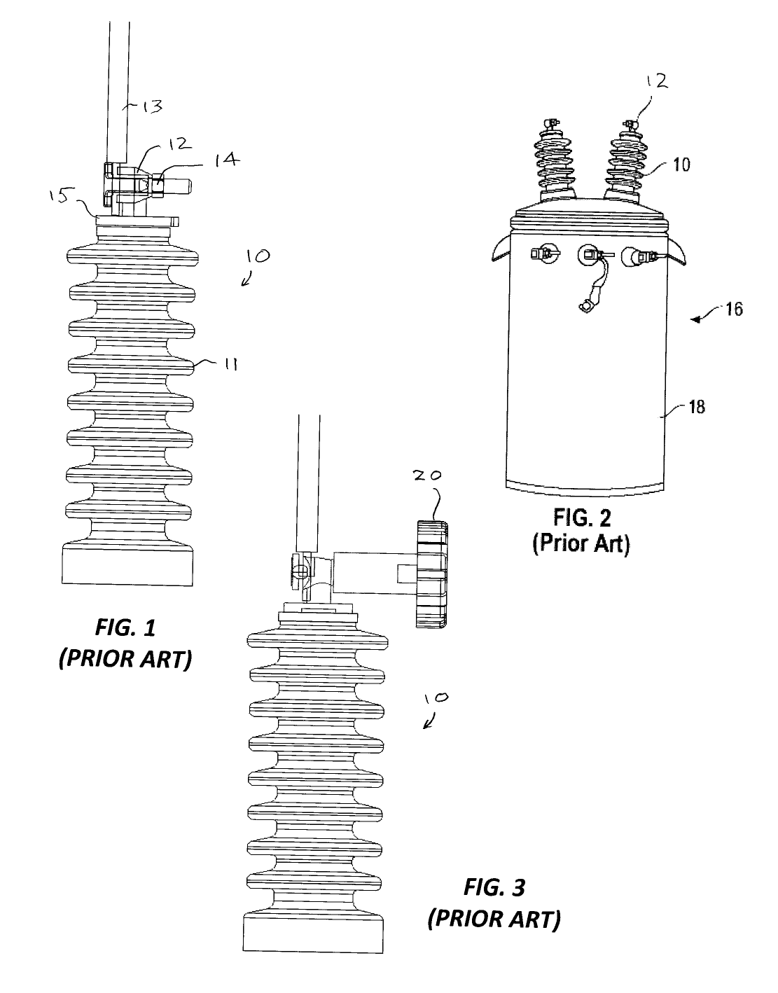

Elements labeled with the same numerals in the various figures may be identical or similar.

### DETAILED DESCRIPTION

A bushing cover is described that can be used with bushings having various types of tightening handwheels or no handwheel at all. The cover completely covers the handwheel to prevent flashover between the energized handwheel and the cover.

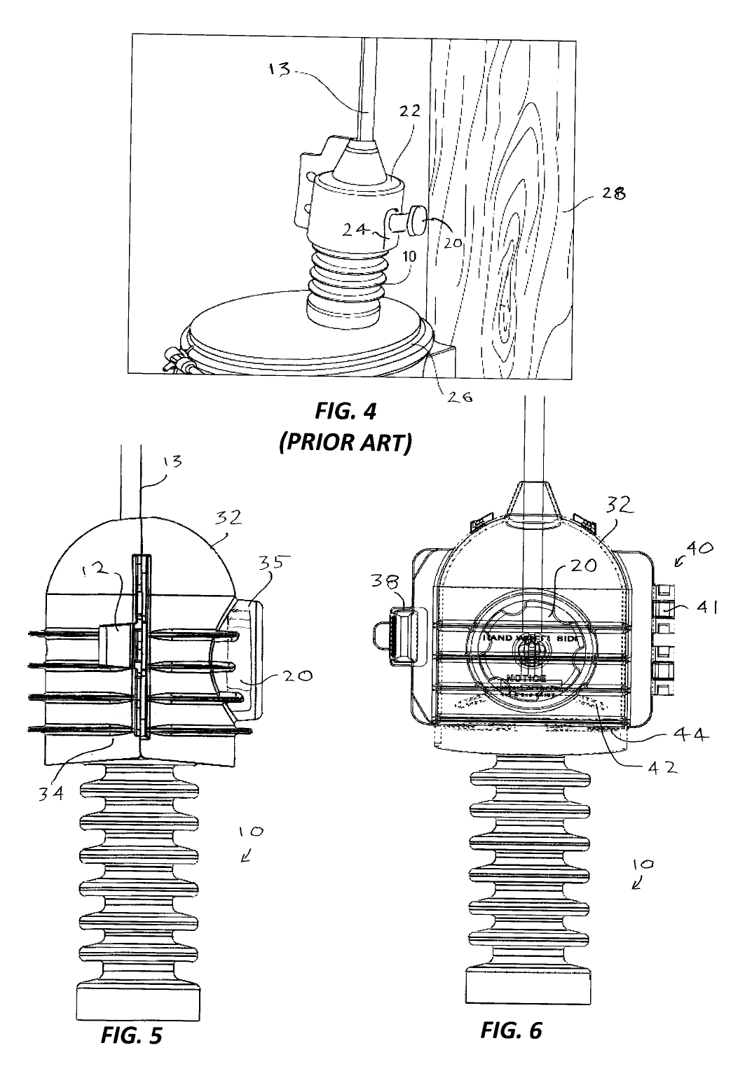

FIG. 5 is a side-transparent view of a dielectric (e.g., polymer) cover 32, where the cover 32 surrounds the handwheel 20 used for clamping the conductor 13 to the metal connector 12. The cover 32 has two hinged sections that clamp around the bottom skirt 34 of the bushing for securing the cover 32 in place. The cover 32 does not contact the handwheel 20 or any other energized parts. The cover 32 has an expanded portion 35 that accommodates the handwheel 20. The expanded portion 35 may extend out about one inch from the remaining surface of the cover 32.

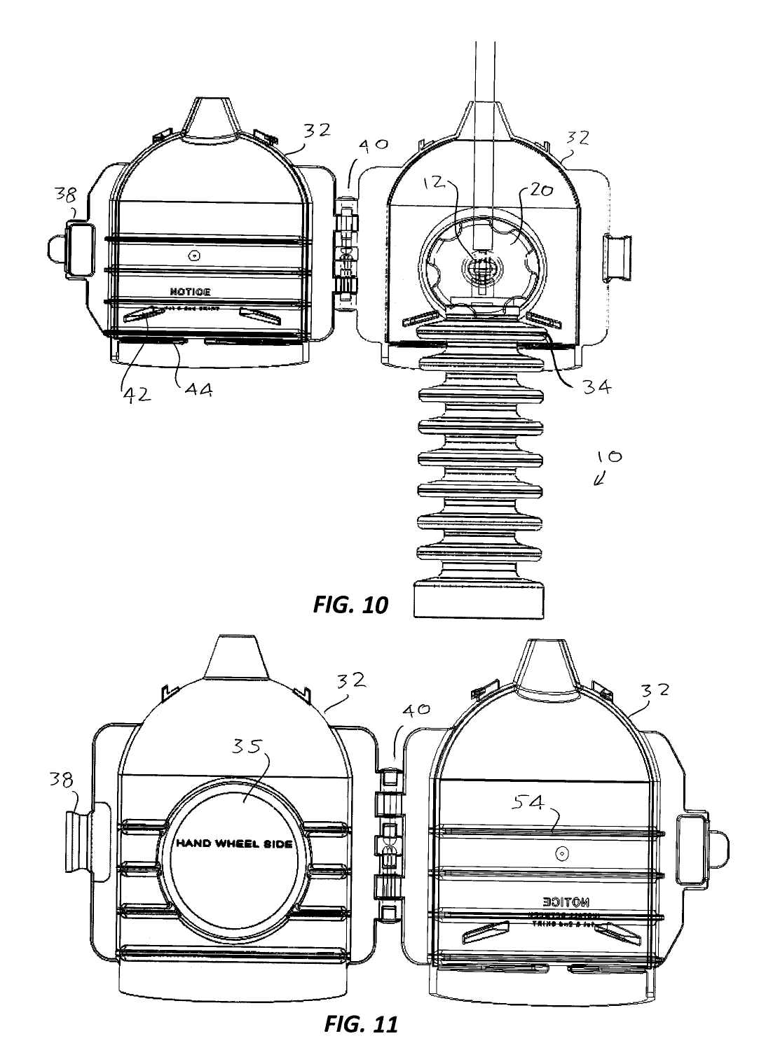

FIG. 6 is a transparent front view of the cover 32 showing a releasable snap-connector 38, that secures the two halves of the cover 32 together, and a hinge 40 of the cover 32. The hinge 40 may consist of two pieces connected together with one or more pins 41. FIG. 6 also shows an inner molded bottom section of the cover with top resilient tabs 42 that contact the top of the top skirt 34 of the bushing 10, and bottom resilient tabs 44 that contact the bottom of the top skirt 34 (FIG. 10) for securely fitting the cover 32 over the bushing insulator to prevent slippage. The tabs 42 and 44 are an integral molded part of the cover 32.

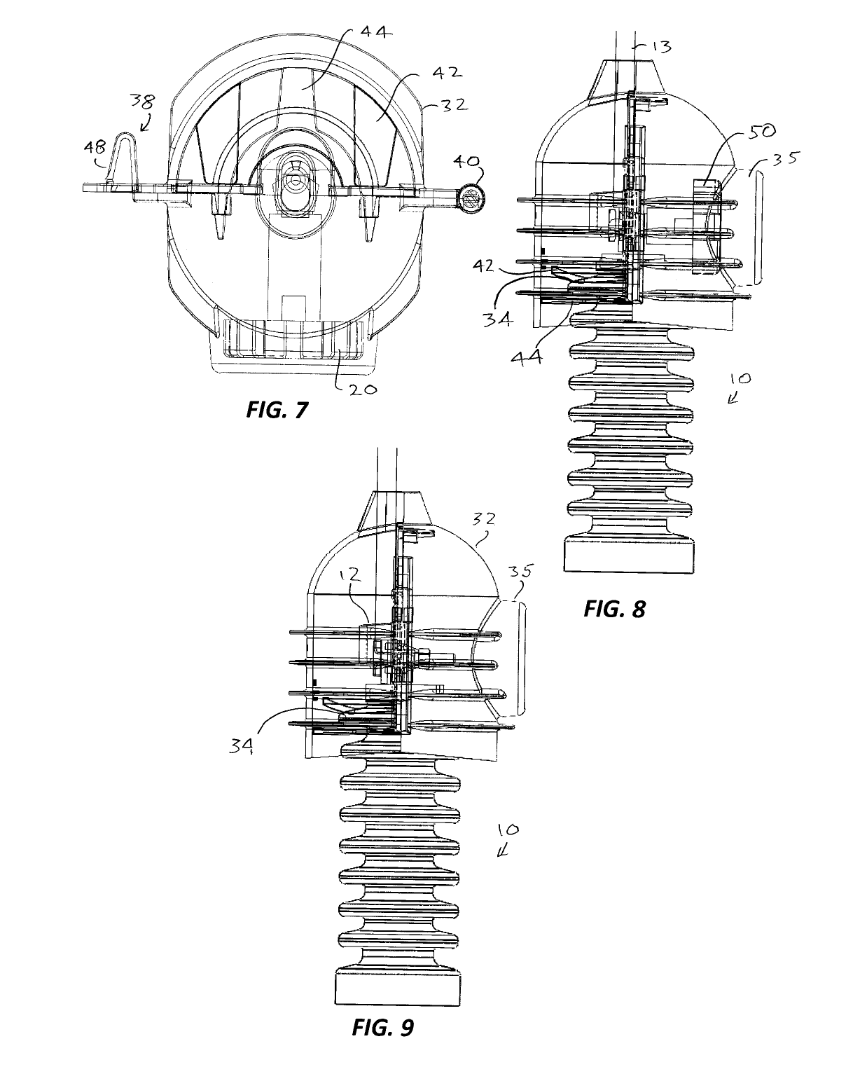

FIG. 7 is a transparent top-down view of the cover 32 showing the latching snap-connector 38 and the hinge 40 and also showing molded tabs 42 and 44 internal to the cover 32 that securely fit under and over the top skirt 34 of the ceramic bushing for securing the cover 32 in place. The snap-connector 38 includes a resilient molded piece 48 on one half of the cover 32 that enters a slot in the other half of the cover 32 and then locks the two halves together.

FIG. 8 is similar to FIG. 5 but the handwheel 50 has a shorter neck.

FIG. 9 shows the same cover 32 over a bushing 10 that does not use a handwheel.

FIG. 10 shows the inner portion of the cover 32 when open, showing all the features described above.

FIG. 11 shows the outside of the cover 32 when open. The molded ribs 54 on the outside surface provide rigidity to the cover 32 and prevent water from forming a continuous path along the surface of the cover 32.

Other shapes of covers may be used to surround the metal connector and handwheel of a bushing. The hinge portion may be a bendable, weakened molded portion of the cover, or may be two pieces connected with a pin (as shown), or may be any other hinge portion. The connector portion of the cover may be a snap connector, as shown, or any other type of connector, such as a hinged tab.

Having described the invention in detail, those skilled in the art will appreciate that, given the present disclosure, modifications may be made to the invention without departing from the spirit of the inventive concept described herein. Therefore, it is not intended that the scope of the invention be limited to the specific embodiments illustrated and described.

What is claimed is:

1. A dielectric bushing cover for a bushing configured for use with high voltage equipment, the bushing having an insulating portion and a metal connector for attachment to a wire, the bushing cover comprising:
a first section and a second section, the first section and second section being connected by a hinge portion and a connector portion;
the cover having a securing portion near its bottom for securing to one or more skirts of the bushing; and
the cover having an expanded portion that surrounds a grippable handwheel connected to the metal connector.

2. The bushing cover of claim 1 wherein the securing portion comprises one or more first resilient tabs that contact a top surface of a skirt of the bushing, and one or more second resilient tabs that contact a bottom surface of the skirt for securing the cover in place.

3. The bushing cover of claim 1 further comprising the cover covering the bushing, wherein the bushing includes the grippable handwheel connected to the metal connector for clamping the wire to the metal connector, wherein the cover is secured over the metal connector and handwheel.

4. The bushing cover of claim 1 wherein the connector portion comprises a resilient latching connector.

5. The bushing cover of claim 1 wherein the hinge portion comprises one or more pins.

6. The bushing cover of claim 1 wherein the hinge portion comprises a bendable portion of the cover.

7. The bushing cover of claim 1 wherein the first section is a first single molded piece, and the second section is a second single molded piece.

8. The bushing cover of claim 1 wherein the handwheel has a neck portion and a grippable portion, where the neck portion engages a clamp for the wire.

9. A structure comprising a bushing, for use with high voltage equipment, and a dielectric bushing cover, the structure comprising:
the bushing having an insulating portion and a metal connector for attachment to a wire, the bushing including a grippable handwheel connected to the metal connector for clamping the wire to the metal connector,
wherein the cover is secured over the metal connector and handwheel, the bushing cover comprising:
a first section and a second section, the first section and second section being connected by a hinge portion and a connector portion;
the cover having a securing portion near its bottom for securing to one or more skirts of the bushing; and
the cover having an expanded portion that surrounds the grippable handwheel connected to the metal connector, wherein the cover is secured over the metal connector and handwheel.

10. The structure of claim 9 wherein the securing portion comprises one or more first resilient tabs that contact a top surface of a skirt of the bushing, and one or more second resilient tabs that contact a bottom surface of the skirt for securing the cover in place.

11. The structure of claim 9 wherein the connector portion comprises a resilient latching connector.

12. The structure of claim 9 wherein the hinge portion comprises one or more pins.

13. The structure of claim 9 wherein the hinge portion comprises a bendable portion of the cover.

14. The structure of claim 9 wherein the first section is a first single molded piece, and the second section is a second single molded piece.

15. The structure of claim 9 wherein the handwheel has a neck portion and a grippable portion, where the neck portion engages the metal connector for the wire.

16. A method for insulating energized portions of a bushing, the bushing having an insulating portion and a metal connector, the metal connector being connected to a grippable handwheel for turning to clamp a wire to the connector, the method comprising:
providing a bushing cover comprising:
a first section and a second section, the first section and second section being connected by a hinge portion and a connector portion;
the cover having a securing portion near its bottom for securing to one or more skirts of the bushing; and
the cover having an expanded portion that surrounds the grippable handwheel connected to the metal connector;
positioning the cover over the metal connector and the handwheel to surround the handwheel; and
securing the first section to the second section using the connector portion of the cover, while securing the cover to the one or more skirts of the bushing.
